(19) United States
(12) Patent Application Publication
(10) Pub. No.: US 2023/0234457 A1
(43) Pub. Date: Jul. 27, 2023

(54) ELECTRIC VEHICLE ZERO EMISSION ONBOARD CHARGING SYSTEM

(71) Applicant: James Richard MOONEY, Flushing, NY (US)

(72) Inventor: James Richard MOONEY, Flushing, NY (US)

(21) Appl. No.: 18/124,442

(22) Filed: Mar. 21, 2023

Related U.S. Application Data
(63) Continuation-in-part of application No. 16/799,779, filed on Feb. 24, 2020, now abandoned.
(60) Provisional application No. 62/804,114, filed on Feb. 25, 2019.

(51) Int. Cl. B60L 53/14; B60L 7/10

(52) U.S. Cl. CPC B60L 53/14; B60L 7/10; B60L 2210/40

(57) ABSTRACT

Disclosed is a Zero Emission Onboard Charging System that charges the main battery of an electric vehicle when the vehicle is being driven in full operation or is at rest. The Zero Emission Onboard Charging System includes at least one direct current (DC) belt driven generator, at least one wheel, at least one pulley attached to the at least one wheel and configured to be attached by belts to the at least one DC belt driven generator, the at least one DC belt driven generator being configured to be driven by the belts attached to the at least one pulley while the electric vehicle is being driven, a voltage regulator wired to the at least one DC belt driven generator, the voltage regulator being configured to regulate DC power received from the at least one DC belt driven generator and to output a grid-equivalent alternating current (AC) charge output, a charging box wired to the voltage regulator, the charging box being configured to receive the charge output from the voltage regulator, a charge cable having two ends configured with a plug, wherein a first end is plugged into the charging box, and wherein the charge cable is configured to receive the charge output from the charging box, a charge port connected to the charge cable by a second end of the charge cable being plugged into the charge port, the charge port being configured to receive the charge output through the charge cable, and a main battery wired to the charge port, the main battery being configured to receive the charge output from the charge port while the electric vehicle is being driven.

### PRIORITY

This application is a Continuation-In-Part of U.S. Application Serial No. 16/799,779, filed on Feb. 24, 2020, in the U.S. Pat. and Trademark Office, which claims priority under 35 U.S.C. §119(e) to U.S. Provisional Application Serial No. 62/804,114, which was filed in the U.S. Pat. and Trademark Office on Feb. 25, 2019, the disclosure of each of which is incorporated herein by reference in their entireties.

### BACKGROUND

### 1. Field

The present disclosure relates generally to a Zero Emission Onboard Charging System, and more particularly, to an onboard recharging system mounted in an electric vehicle and method for recharging a main battery that uses the motion of the wheels to generate electrical charge, which charges batteries and or powers an engine of an electric vehicle when the vehicle being driven and is in full operating motion or is at rest.

### 2. Description of the Related Art

Recently, the electric vehicle has increased in popularity, mainly due to the substantial increase in miles travelled on a single charge, as compared to miles per gallon generally achieved on a single tank of gasoline, in the case of gasoline-powered vehicles. This trend is likely to continue, at least in view of recent government mandates on vehicle manufacturers for higher vehicle efficiency.

As an example, the recently-introduced Tesla Model 3 is an electric vehicle that includes a lithium-ion under floor-mounted battery which powers an electric motor that has been tested as achieving a 75 mile per hour (75-mph) highway range of 300 plus miles, and estimated by the Environmental Protection Agency (EPA) as being capable of achieving a 265-300 mile range at cruising speed.

Much like the other electric vehicles, the Tesla Model 3 electric vehicles and those being developed by other electric vehicle manufacturers, the main battery is recharged via an onboard charger that, when connected to a 110 Volt (110 V) standard wall outlet (Level 1) or a 220-240 Volt (220-240 V) custom home or public charging station (Level 2) supplies a charge to the battery and adds miles of range to the electric vehicle.

However, the conventional charging unit suffers from the inability to recharge the battery while the electric vehicle is being driven and suffers from the requirement to plug in the electric vehicle to the power grid or public charging stations, which is an inconvenience to the user of the electric vehicle and has caused a “range anxiety” that has restricted electric vehicle popularity.

In addition, charging stations for electric vehicles are far less prevalent in comparison to gasoline stations for gasoline-powered vehicles, which is a further inconvenience to the electric vehicle user.

Moreover, although electric vehicles are generally more efficient than gasoline powered vehicles, electric vehicles tend to have a substantially lower mileage range between charges, compared to the mileage range between fueling for the typical gasoline powered vehicle, which is another inconvenience to the user of the electric vehicle.

Moreover, the use of onboard charging systems for electric vehicles using a generator which requires fuel such as diesel, gasoline, natural gas or propane requires refueling and the at least one belt driven generator emits fuel emissions which are uncomfortable and unhealthy for users and are environmentally detrimental.

As such, there is a need in the art for an Zero Emission Onboard Charging System which uses the forward spinning motion of the wheels when operating an electric vehicle that recharges the main battery in the electric vehicle while the user is driving the electric vehicle which increases the mileage range and flexibility of the battery recharge while also reducing the need for stationary charging of the electric vehicle with stationary charging stations and recharges the electric vehicle while the user is driving the electric vehicle and generates zero emissions from the onboard charging system. The Zero Emission Onboard Charging System utilizes a unique pulley system attached to the wheels of an electric vehicle also attached to a belt driven generator with which the Zero Emission Onboard Charging System generates power to recharge the main battery system in the electric vehicle while the user is driving the electric vehicle to offset some of consumption of main battery power similar to regenerative braking being consumed by the electric vehicle while operating. The power generated from the Zero Emission Onboard charging system while the user is driving the electric vehicle is sent directly to the main battery system in the electric vehicle to provide extended range to the electric vehicle.

### SUMMARY

The present disclosure has been made to address at least the above-mentioned problems and/or disadvantages and to provide at least the advantages described below.

Accordingly, an aspect of the present disclosure is to provide a Zero Emission Onboard Charging system for an electric vehicle that does not require any fuel to power the at least one belt driven generator, which enables a user to charge the main battery of the electric vehicle while the vehicle is being driven any time or any place.

Another aspect of the present disclosure is to provide a charging system for an electric vehicle by charging main battery system directly while the user is driving the electric vehicle, which significantly increases the range that the battery system can achieve on a single charge from the power grid when compared to the conventional charging for electric vehicles.

Another aspect of the present disclosure is to provide an Zero Emission Onboard Charging System for electric vehicles, which reduces the need to “plug-in” and charge the electric vehicle at a charging station or a 110 V or 220 V outlet and solely receive the charge via the power grid while still providing the option to charge from the grid if ever desired.

According to an aspect of the present disclosure, a Zero Emission Onboard Charging System for a vehicle includes at least one direct current (DC) belt driven generator, at least one wheel, at least one pulley attached to the at least one wheel and configured to be attached by belts to the at least one DC belt driven generator, the at least one DC belt driven generator being configured to be driven by the belts attached to the at least one pulley while the electric vehicle is being driven, a voltage regulator wired to the at least one DC belt driven generator, the voltage regulator being configured to regulate DC power received from the at least one DC belt driven generator and to output a grid-equivalent alternating current (AC) charge output, a charging box wired to the voltage regulator, the charging box being configured to receive the charge output from the voltage regulator, a charge cable having two ends configured with a plug, wherein a first end is plugged into the charging box, and wherein the charge cable is configured to receive the charge output from the charging box, a charge port connected to the charge cable by a second end of the charge cable being plugged into the charge port, the charge port being configured to receive the charge output through the charge cable, and a main battery wired to the charge port, the main battery being configured to receive the charge output from the charge port while the electric vehicle is being driven.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a schematic diagram of the Zero Emission Onboard Charging System according to an embodiment;

FIG. 2 illustrates a Zero Emission Onboard Charging System installed in a Chevrolet Bolt electric vehicle, according to an embodiment;

FIG. 3 illustrates the Zero Emission Onboard Charging System installed in a Tesla Model 3, according to an embodiment; and

FIG. 4 illustrates a layout of the Zero Emission Onboard Charging System according to an embodiment.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure. Descriptions of well-known functions and/or configurations will be omitted for the sake of clarity and conciseness.

The terms and words used in the following description and claims are not limited to their dictionary meanings, but are merely used to enable a clear and consistent understanding of the present disclosure. Accordingly, it should be apparent to those skilled in the art that the following description of embodiments of the present disclosure is provided for illustrative purposes only and not for the purpose of limiting the present disclosure as defined by the appended claims and their equivalents.

Singular terms “a,” “an,” and “the” include plural references unless the context clearly dictates otherwise. For example, reference to “a component surface” includes reference to one or more of such surfaces.

The embodiments are described herein by way of illustration only and should not be construed in any way to limit the scope of the present disclosure. Those skilled in the art will understand that the principles of the present disclosure may be implemented in any suitably arranged series of components and electronic devices.

As used herein, the term “substantially” indicates that the recited characteristic, parameter, or value need not be achieved exactly, but that variations such as tolerances, measurement errors, measurement accuracy limitations and other factors known to those of ordinary skill in the art, may occur in amounts that do not preclude the effect the characteristic was intended to provide.

The expressions “have,” “may have,” “include,” and “may include” as used herein indicate the presence of corresponding features, such as numerical values, functions, operations, or parts, and do not preclude the presence of additional features. The expressions “A or B,” “at least one of A or/and B,” or “one or more of A or/and B” as used herein include all possible combinations of items enumerated with them. For example, “A or B,” “at least one of A and B,” or “at least one of A or B” indicate (1) including at least one A, (2) including at least one B, or (3) including both at least one A and at least one B.

Terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. A first element may be referred to as a second element without departing from the scope the present disclosure, and similarly, a second element may be referred to as a first element.

When a first element is “operatively or communicatively coupled with/to” or “connected to” another element, such as a second element, the first element may be directly coupled with/to the second element, and there may be an intervening element, such as a third element, between the first and second elements. To the contrary, when the first element is “directly coupled with/to” or “directly connected to” the second element, there is no intervening third element between the first and second elements.

All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

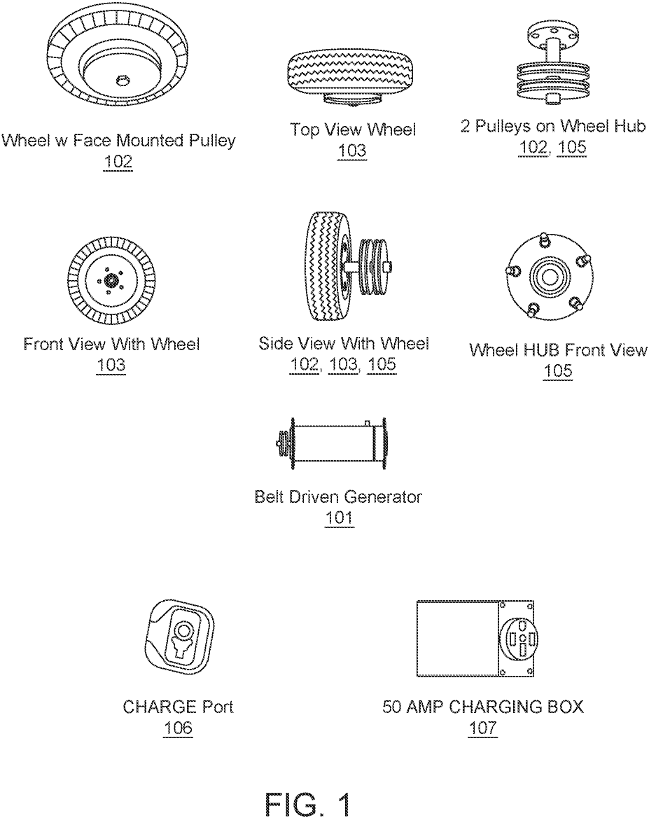

FIG. 1 illustrates a schematic diagram of the Zero Emission Onboard recharging system, according to an embodiment.

Referring to FIG. 1, the Zero Emission Onboard Charging System 100 includes at least one belt driven generator 101 including a power monitoring display and at least one pulley 102 attached to at least one metal rear wheel 103 adapted for installation in an electric vehicle. The wheel with at least one pulley 102 may be custom steel pulleys mounted on a wheel hub 105 and bolted to each face of the rear wheel 103. The at least one belt driven generator 101 is a 220 V direct current (DC) generator in order for sufficient power to be supplied to charge the main battery 111 of the electric vehicle in a time-efficient manner. The DC generator is connected to a voltage regulator 104 that supplies grid-equivalent alternating current (AC) power or charge output. That is, the voltage regulator 104 receives DC input and supplies AC output.

The at least one belt driven generator 101 is connected to a voltage regulator 104 by a positive wire, though which the charge is supplied, while the voltage regulator 104 is connected by larger group of about three (3) wires to a charging box 107 delivering a 220 V-240 V (level 2) charge output, and having an on/off switch and voltage meter. A ground wire is connected from the voltage regulator to ground. The voltage meter shows the current output from the voltage regulator, based on and relative to the speed of travel of the electric vehicle. The charge output is fed to an electric vehicle (EV) charge cable (Level 2) 112 that is plugged into the charging box 107 on one end and is plugged into a charge port 106 on another end to charge the main battery 111. The charge port 106 and main battery 111 are programmed to be charged while the vehicle is being driven. The main battery 111 is a lithium ion battery having a variable rating based on the electric vehicle being customized for each Zero Emission Onboard Charging System, as well as the variable electrical connections to the at least one belt driven generator.

The 220 V charge output along with output power from the belt driven generator can be either directly connected to the main battery 111 or to the charge port 106 to charge the main battery 111 of the electric vehicle while the user is driving the electric vehicle or alternatively connected to a regenerative power input to charge the main battery 111 while the user is driving the electric vehicle.

The at least one 220 V DC belt driven generator 101 is driven by the belts attached to the pulley 102 and wheel 103 while the electric vehicle is being driven, meets required safety requirements for use in electric vehicles, may be any other similar belt driven generators on the market and known to those skilled in the art, and may be up to 240 V in terms of power. The at least one belt driven generator 101 provides the charge to the electric vehicle main battery 111 either directly from the charging box 107 or through the charge port 106 which is modified to allow charging of the main battery 111 while the electric vehicle is being driven. This improves over the art at least because electric vehicles are presently restricted from being charged via a charge port while the electric vehicle is being driven.

The electric outlet charging box 107 is a 220 V box with plug receptacles in FIG. 1, but may also be a 240 V box when a 240 V belt driven generator is used. The charging box 107 is a standard box for connecting an electric plug on a charging cord 112 for electric vehicles and may also provide a 220-240 V charge through a 220-240 V directly into battery terminals connected to the main battery 111 directly or to charge port 106 adapted to allow for charging the main battery 111 while the user is driving the electric vehicle for installation in connected to the main battery system. The charging box 107 is connected to the voltage regulator 104 for measuring DC voltage output from the at least one belt driven generator 101 while the at least one belt driven generator 101 is being operated. As previously noted, the voltage regulator 104 supplies an AC charge output. The charge port 106 sends the AC charge output to the main battery through a high voltage connection, which is also adapted for installation in the rear compartment 108 and can also direct the charge output through the main battery 111 to the electric vehicle engine in order to propel the electric vehicle and extend the range of the electric vehicle.

When activated, i.e., when the electric vehicle is in motion and is being operated by the user, the belt driven generator provides a charge to the voltage regulator 104 and outlets of the charging box 107, and the charging box 107 provides a charge output through the charging cable 112 which is plugged into the receptacles of the charge port 106 that is wired to the main battery 111 in the electric vehicle when the Zero Emission Onboard Charging System 100 is operating and being driven. In this manner, the charge output may charge the main battery system powering the electric vehicle while a user is operating the electric vehicle, thereby extending range for driving the electric vehicle. That is, the charge cable 112 is plugged into the charge port 106 of the electric vehicle and the charge port 106 is modified to enable the at least one belt driven generator system to charge the main battery 111 of the electric vehicle while the user is driving the electric vehicle. This is effectively the equivalent of the conventional plugging- in of the electric vehicle charging cable in a 220 V plug receptacle in one’s home or garage or at a stationary charging station.

The electric vehicle programming is modified to also allow the main battery 111 to be charged with power generated by the at least one belt driven generator in a similar manner as power from regenerative braking is presently delivered to the main battery while the user is driving the electric vehicle. Since electric vehicles are designed to remain in “Park” if the charging cord is connected to the electric vehicle when turned on and since the charge port is connected via the electric vehicle charging cable to a stationary charging station, the charge port 106 connection is modified in the present application to enable the charge port 106 to receive the charge output from the at least one belt driven generator 101 by plugging the charge cord 112 from the charging box 107 into the plug receptacle of the charge port 106 installed in the rear interior compartment of the electric vehicle while the user is driving the electric vehicle.

To deliver the charge while operating the electric vehicle, the charge from the power output of the at least one belt driven generator 101 will be received through the charge cable 112 at the charge port 106 and to the main battery 111 enabling charging of the electric vehicle while the user is driving the electric vehicle or via a “plug less” (i.e., wireless) electronic relay of the charge from the belt driven generator 101 to the main battery 111.

That is, the disclosed Zero Emission Onboard Charging System 100 reduces reliance solely on the requirement of using a stationary charging station. The charge connection to the main battery 111 enables the charge to be supplied to the main battery 111 while the user is driving the electric vehicle. thereby enabling the electric vehicle to be fully drivable while the Zero Emission Onboard recharging system 100 is being operated.

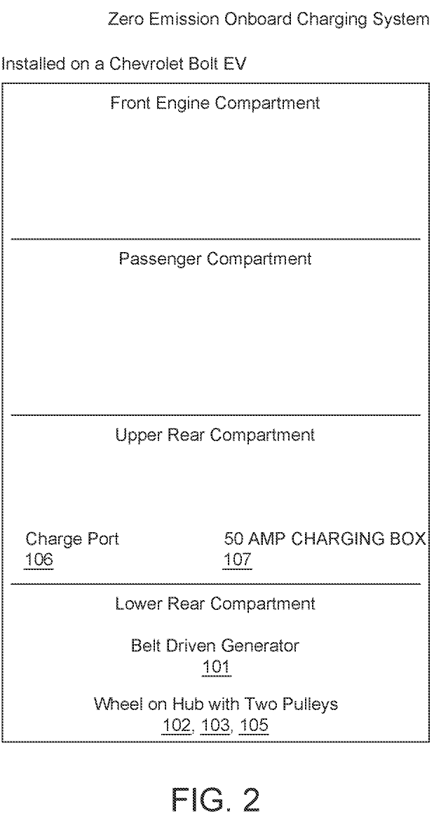

Referring to FIG. 2, a diagram is provided showing the location of the installation of the Zero Emission Onboard Charging System components in a Chevrolet Bolt vehicle.

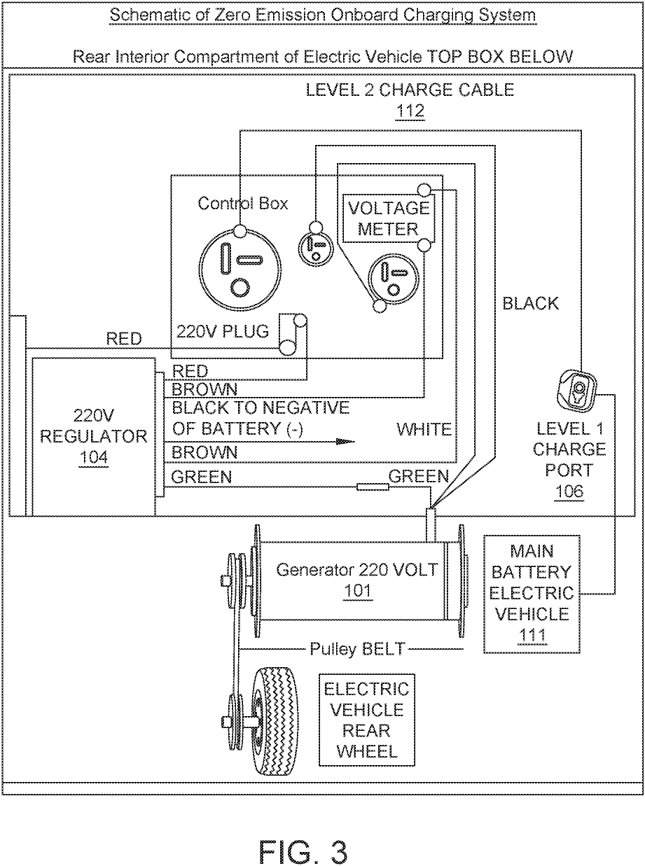

Referring to FIG. 3, a diagram is provided showing the location of the installation of the Zero Emission Onboard Charging System components in a Tesla Model 3 vehicle as well as the wiring connections of each of the components of the system.

Specifically, the voltage regulator 104 is a 220 alternating current (AC) solid state control device which controls the voltage from the direct current (DC) 220 V belt driven generator 101 by sensing the AC output voltage drop when a load is applied, or by sensing a voltage increase when the load is removed. This is accomplished instantaneously by the preset AC output voltage which is electronically compared to the input DC voltage applied to the field through the voltage regulator 104. The AC output voltage is factory calibrated at 230 volts alternating current (VACS) (+ -) 5 VACS with a 12 to 14 DC volt input to the voltage regulator from the DC 220 V belt driven generator. During variable load applications from no load to full load the voltage regulator 104 will hold the AC output voltage steady at between 230 and 220 VAC. The voltage regulator 104 is ruggedly designed for severe commercial use because of high quality parts. There are no moving parts or no relays or moving electrical contacts or transformers. This device compensates for all over-voltage conditions for use with most electronic equipment, is designed ready for use with any Negative ground in the chassis of the electric vehicle and produces 220 VAC output when used with the 220 V belt driven generator in the Zero Emission Onboard Charging system. The following describes the connections of the components of the system.

The red wire is connected from the voltage regulator to a vacant brass screw on the switch in the control box. (NOTE: This is the hot + 12-volt DC source. Installed in a 30 Amp inline fuse in the circuit connected to positive terminal of the 12-volt battery in the front compartment under the hood of the electric vehicle.

The double brown wires are connected from the voltage regulator such that one brown wire is connected to the vacant brass screw of the receptacle on the charging box 107 with 220 V plug outlets and the other brown wire is connected to the other vacant brass screw on the same receptacle.

The black wire is connected from the voltage regulator, directly to the (-) negative side of the battery, for grounding.

The green wire is connected from the voltage regulator 104 to the green wire of the belt driven generator 101.

The white wire is connected from the belt driven generator 101 to the round receptacle as shown to the screw together with the white installed jumper wire that is connected to the rectangle receptacle.

The black wire is connected from the belt driven generator 101 to the vacant screw on the round overload in the charging box 107.

The five-pin connector on the wire harness is plugged into the voltage regulator.

The pulley on the rear exterior is connected with a belt to the DC 220 V belt driven generator 101.

The Level 2 charge cable 112 is plugged into the charging box 107 220 V AC plug receptacle (equivalent to plugging into a custom 220 V plug receptacle at home) and the other end of the Level 2 charging cable 112 is plugged into the charge port 106 connected to the main battery 111. The electric vehicle software is reprogrammed to enable charging while the electric vehicle is being driven. The charging port is relocated and installed in the interior rear compartment of the electric vehicle in such a manner to allow charging while driving or stationary charging while the electric vehicle is parked.

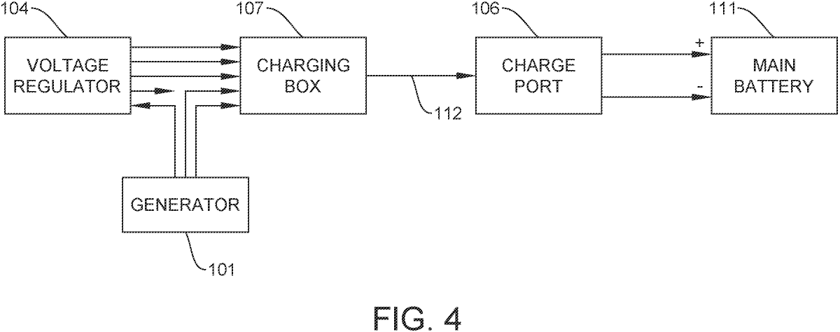

Referring to FIG. 4, a layout of the Zero Emission Onboard Charging system according to an embodiment is provided. Specifically, each of the components described above is illustrated as connected in the charging system of the present application.

The Zero Emission Onboard Charging System 100 is shown from the perspective of components of the zero emission onboard charging system of the electric vehicle, which may vary in terms of physical location in various electric vehicles as opposed to an embodiment as it has been installed in the Tesla Model 3. However, the electric vehicles may vary and be supplied by various EV manufacturers, including hatchbacks, pickup trucks, sedans, and other electric vehicle designs in such case as components will be installed and the onboard charging system contained herein configured accordingly.

The at least one belt driven generator is located inside of electric vehicle such that it can be attached to the pulley connected to a wheel, which generally comprises the front or rear compartments of the electric vehicle.

Specifically, the undercarriage constitutes a metal platform onto which the at least one belt driven generator is attached to the chassis of the electric vehicles and includes custom pulleys that are mounted to either fore or aft of the rear wheels via custom connectors to wheel lug nut threads. The at least one belt driven generator is mounted onto steel mounting plates which extend under the rear compartment and are fastened to the electric vehicle chassis and/or the flooring for structural integrity, such as by bolting or another suitable manner.

Embodiments of the present disclosure disclosed in the specification and the drawings are only particular examples disclosed in order to easily describe the technical matters of the present disclosure and assist with comprehension of the present disclosure, and do not limit the scope of the present disclosure. Therefore, in addition to the embodiments disclosed herein, the scope of the embodiments of the present disclosure should be construed to include all modifications or modified forms drawn based on the technical aspects of the embodiments of the present disclosure.

While the present disclosure has been described with reference to various embodiments, various changes may be made without departing from the spirit and the scope of the present disclosure, which is defined, not by the detailed description and embodiments, but by the appended claims and their equivalents.

1. A Zero Emission Onboard Charging System for an electric vehicle, comprising:
at least one direct current (DC) belt driven generator;
at least one wheel;
at least one pulley attached to the at least one wheel and configured to be attached by belts to the at least one DC belt driven generator, the at least one DC belt driven generator being configured to be driven by the belts attached to the at least one pulley while the electric vehicle is being driven;
a voltage regulator wired to the at least one DC belt driven generator, the voltage regulator being configured to regulate DC power received from the at least one DC belt driven generator and to output a grid-equivalent alternating current (AC) charge output;
a charging box wired to the voltage regulator, the charging box being configured to receive the charge output from the voltage regulator;
a charge cable having two ends configured with a plug, wherein a first end is plugged into the charging box, and wherein the charge cable is configured to receive the charge output from the charging box;
a charge port connected to the charge cable by a second end of the charge cable being plugged into the charge port, the charge port being configured to receive the charge output through the charge cable; and
a main battery wired to the charge port, the main battery being configured to receive the charge output from the charge port while the electric vehicle is being driven.

2. The Zero Emission Onboard Charging System of claim 1,
wherein the charge cable is a level 2 charge cable, and
wherein the charge output is 220 volts - 240 volts.

3. The Zero Emission Onboard Charging System of claim 2,
wherein the at least one DC belt drive generator is powered by the at least one pulley connected to the at least one wheel on the electric vehicle when the at least one wheel is rotated.

4. The Zero Emission Onboard Charging System of claim 3,
wherein no fuel is required to operate the electric vehicle and no fuel emission is discharged from the electric vehicle, and
wherein the main battery is a lithium ion battery.

5. A Zero Emission Onboard Charging method for an electric vehicle, comprising:
mounting least one pulley to at least one wheel;
attaching the at least one pulley by belts to at least one direct current (DC) belt driven generator, the at least one DC belt driven generator being configured to be driven by the belts attached to the at least one pulley;
wiring a voltage regulator to the at least one DC belt driven generator on one end, the voltage regulator being configured to regulate DC power received from the at least one DC belt driven generator and to output a grid-equivalent alternating current (AC) charge output;
wiring a charging box to another end of the voltage regulator, the charging box being configured to receive the charge from the voltage regulator;
plugging a charge cable having two ends configured with a plug into a plug receptacle in the charging box on one end;
connecting the charge port to the charge cable by another end of the charge cable being plugged into the charge port, the charge port being configured to receive the charge through the charge cable; and
wiring a main battery to the charge port, the main battery being configured to receive the charge from the charge port while the electric vehicle is being driven.

6. The Zero Emission Onboard Charging method of claim 5,
wherein the charge cable is a level 2 charge cable, and
wherein the charge is 220 volts - 240 volts.

7. The Zero Emission Onboard Charging method of claim 6,
wherein the at least one DC belt drive generator is powered by the at least one pulley connected to the at least one wheel on the electric vehicle when the at least one wheel is rotated.

8. The Zero Emission Onboard Charging method of claim 7,
wherein no fuel is required to operate the electric vehicle and no fuel emission is discharged from the electric vehicle, and
wherein the main battery is a lithium ion battery.
